(19) United States
(12) Patent Application Publication
(10) Pub. No.: US 2015/0064377 A1
(43) Pub. Date: Mar. 5, 2015

(54) LAMINATED BOARD

(71) Applicants: Patrick Petrus Antonius Maria Van Berlo, Hamilton (NZ); Jason Paul Rogers, Hamilton (NZ)

(72) Inventors: Patrick Petrus Antonius Maria Van Berlo, Hamilton (NZ); Jason Paul Rogers, Hamilton (NZ)

(73) Assignee: CORCEL IP LIMITED, Hamilton (NZ)

(21) Appl. No.: 14/236,443

(22) PCT Filed: Aug. 1, 2012
(86) PCT No.: PCT/NZ2012/000133

§ 371 Date: Mar. 24, 2014

(30) Foreign Application Priority Data
Aug. 1, 2011 (NZ) 594363

(51) Int. Cl. B31F 1/28; B32B 3/12; B32B 29/08; B26D 1/56; B23K 26/40; B31F 1/08; B23K 26/00; B23K 26/08; B23K 26/38; B32B 3/26; B31F 1/30

(52) U.S. Cl. CPC B31F 1/2822; B32B 3/266; B32B 3/12; B32B 29/08; B26D 1/56; B31F 1/305; B31F 1/08; B23K 26/0084; B23K 26/0846; B23K 26/381; B23K 26/406; B32B 2250/02; B32B 2250/03; B32B 2250/26; B32B 2250/40; B32B 2307/724; B32B 2307/726; B32B 2439/70; B32B 2439/62
USPC 428/34.2; 428/137; 428/116; 83/30; 83/660; 219/121.7; 83/326

(57) ABSTRACT

A machine is provided for creating perforated corrugated board, wherein the machine includes: a) at least one apparatus configured to perforate an “ACP” corrugated board after a corrugated board exits the corrugators as part of a continuous process, so that the perforations are spread over at least a portion of the corrugated board.

### TECHNICAL FIELD

The present invention relates to improvements in and relating to corrugated board and the manufacture thereof.

### BACKGROUND ART

Corrugated board has a variety of different uses ranging from creating boxes in the packaging industry through to advertising and creating point of sale display stands.

In particular, the use of corrugated board to create boxes for transporting items such as produce is well known. It is applications such as these that the present invention has particular utility.

Typically when produce is being transported it requires packaging which is breathable to extend the shelf life of the produce. For this reason corrugated board produce boxes typically require one or more clearly visible holes or slots in the walls of the box—to allow for airflow around the produce therein. For example, conventional banana or apple boxes usually have two or more holes in the walls of the box which are usually around 2-5 cm or more in length/height. However, given the relatively large sized “macro” apertures compared to the size of the fruit that is to be stored therein, this can lead to fruit escaping from, or a portion of the fruit body extending outside, the confines of the box. The use of mesh to cover the holes is one solution but is very time consuming and labour intensive and is not conducive to recycling.

In addition, the creation of macro apertures in the walls of the box is not only wasteful, as material needs to be removed, but it also has the affect of weakening the structural integrity of the walls of the box.

Thus, the size and spacing of the apertures is of paramount importance to ensure the strength of the corrugated board.

It would therefore be useful if there could be provided a cheap and non-labour intensive way of creating breathable corrugated board boxes, or materials therefor, as part of a continuous process.

In the prior art the step of perforating paper prior to making corrugated board is disclosed in PT 101980. However, the invention in PT 101980 solely is concerned with enabling the penetration of synthetic resins into corrugated cardboard, by immersion to modify the mechanical, thermal and physical properties of the board. Consequently, PT 101980 is not concerned with alignment of the perforations in each layer to create passages from one side of the board to the other. A further drawback with the invention in PT 101980 is that steps of perforating the paper prior to formation of the corrugated board consequently weakens the tensile strength of the paper, thus negatively impacts on the speed, at which corrugated board can be produced.

It would also be useful if there could be provided semi-perforated corrugated board. That is corrugated board which includes a non-perforated liner sheet layer and a perforated single face layer. Such semi-perforated corrugated board would be useful in the production of boxes or bins which are used when freezing products, such as meat for export. The perforated outer layer enabling cold air to directly contact the inner non-perforated liner sheet for more efficient cooling of the interior of the box and its contents. The perforated layer effectively removing the insulating air barrier found in conventional corrugated paperboard boxes. Thus, resulting in reduced cooling times for pre-packaged meat. The box still however remains effectively sealed due to the non-perforated solid liner layer: such that the box still meets New Zealand MAF (or other over seas governmental or quasi governmental) sterility requirements for packaging of export meat.

It is therefore an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DEFINITIONS

The term ‘closed cell coreboard’ as used herein refers to composite paper board which has at least one first liner sheet and at least one second liner sheet which respectively sandwich a core having a plurality of cells there between. Thus, closed cell coreboard includes honeycomb paper board which has a honeycomb core, or X-board as is manufactured by Xanita of South Africa, or 3C™ board as manufactured by Corcel. X-board and 3C™ board are composite boards comprising a core manufactured from adjacent strips of single or double face corrugated paperboard sandwiched between two liner sheets so that the flutes run orthogonally (i.e. the flute channels extend from the top liner sheet to the bottom liner sheet).

The term ‘corrugated board’ as used herein is a general term which refers to sheet material which includes a corrugated web or core bonded to at least one planar sheet of material. This term therefore includes single face and double face paper board as well as closed cell coreboard and corewrap.

### DISCLOSURE OF THE INVENTION

This specification details several new types of corrugated board which has been perforated in order to provide multiple passageways for the entry/egress of air, water or other fluids through the corrugated board. The specification also details new machines for producing perforated corrugated board.

According to a first aspect of the present invention there is provided corrugated board which includes:
a sheet of corrugated material; and
at least one planar sheet of material bonded to at least one surface of said sheet of corrugated material;
   wherein said corrugated sheet and planar sheet(s) include a plurality of perforations spread over at least a portion of the respective surfaces thereof which are substantially aligned to create passages through the corrugated board, wherein the perforations are dimensioned to be substantially 0.5 mm²-2.00 mm² in size and spaced at least substantially 10 mm apart from one another.

In one preferred embodiment the layer of strips may be bonded to two facing sheets of material one on each edge of the layer of strips.

According to a second aspect of the present invention there is provided a closed cell coreboard which includes a plurality of substantially aligned perforations on each planar facing sheet positioned/spaced to create a passages extending through the core.

According to a third aspect of the present invention there is provided a closed cell coreboard or corewrap which includes:
a layer of strips formed from single face or double face corrugated board;
   wherein said layer of strips are bonded via at least one edge to at least one planar sheet of material (facing sheet) so that the corrugations of the strips extend orthogonally to the facing sheet and wherein said closed cell coreboard has a plurality of substantially aligned perforations on each the facing sheet(s) positioned/spaced to create passages extending through the layer of strips in the closed cell coreboard or corewrap.

The planar and corrugated sheets material used in the present invention may preferably be virgin or recycled paper. However, this need not necessarily been seen as limiting as sheet materials made of other material are envisaged.

In a preferred embodiment the sheet material is Kraft paper.

In some embodiments the corrugated web may be made from recycled paper.

For ease of reference the present invention will now be described in relation to corrugated board made from sheets of paper material as this is the most preferred medium and has the widest range of possible end uses and is relatively inexpensive.

The sheets of material may be bonded via a variety of suitable glues and processes such as are well known in the art without departing from the scope of the present invention.

As will be understood by a person skilled in the art the term perforation refers to a tiny hole.

The actual size of the individual perforations may vary depending on the end application to which the corrugated board is to be applied.

In general the perforations may have a cross-sectional distance, or average cross sectional distance, of substantially 0.5-6.0 mm. However other sizes are envisaged as discussed further below.

In one embodiment the perforations may be substantially 0.5 mm²-2.00 mm² in size.

In a preferred embodiment where the corrugated board is to be used to create a box for transportation of produce, the perforations may have a cross-sectional distance, or average cross sectional distance, of substantially 1.0 mm.

Preferably, said perforations are spaced within a radius of substantially 10-50 mm of one another.

In one embodiment perforations are dimensioned to be substantially 0.5 mm²-2.00 mm² in size, and the perforations are spaced apart from one another a distance of at least substantially 4 mm-10 mm.

For example: if the size of the perforations is 0.5 mm²-1.00 mm² they are spaced apart from adjacent perforations by at least substantially 4 mm-5 mm: and if perforations are 2 mm² in size they are spaced apart from one another by at least 10 mm.

The size of the apertures and their spacing apart from one another are critical to ensure that the structural strength of the corrugated board is not compromised. This is particularly so when the perforations are to be spread over all or a large portion of the surface of the corrugated board. What you do not want is the perforations to form a line of weakness where the corrugated board can be torn.

Another important feature of the size of the apertures is that they are small enough to enable production of perforated board as part of a continuous process as corrugated board exits a corrugator.

The perforations may be located over substantially the entire surface of the board or may be located in one or more discrete regions.

In some embodiments the perforations enable air or other fluids to pass right through the corrugated board and thus the perforations act as passage from one side of the corrugated board through to the other. Consequently, if the corrugated board of the present invention is used to create a box air can travel from outside the box to the inside of the box and vice versa. Similarly, in a corrugated board box of the present invention water can travel from the outside of the box to the inside of the box: a feature which can be used to facilitate the removal of produce from the box without damage. For example, by placing the box in a water tank and letting water enter the box via the perforations so as to displace the produce from therein as the water fills the box.

In some other embodiments wherein the board is in the form of semi-perforated corrugated board, the perforations act as a passage through which air can pass to contact the non-perforated liner sheet to enable heat transfer. Thus, if a box is constructed with a perforated outer layer and a non-perforated inner layer, cold air can pass through the apertures and directly contact the non-perforated layer (effectively bypassing the normal air gap in corrugated board) for more efficient heat transfer. Similarly, more efficient heat transfer can also occur when thawing out frozen items in a semi-perforated corrugated board box.

Among other things the size, spacing, of the perforations, and number of perforations, will depend on a variety of factors associated with the desired end use of the corrugated board, which can include but should not be limited to:
strength of the board;
size of the item to contained within a box constructed from the board;
amount of fluid flow required through the perforations.

According to a fourth aspect of the present invention there is provided a method of manufacturing perforated corrugated board characterised by the step of:
a) forming perforations through the corrugated board or closed cell coreboard once the corrugated board has been formed by bonding a liner sheet(s) to the corrugated core as part of a continuous process wherein said perforations are spread over at least a portion of the corrugated board.

The sheet of paper material may be single face paperboard; double face paperboard; or closed cell coreboard (herein for ease of reference now all simply referred to as “corrugated board”).

According to a fifth aspect of the present invention there is provided a machine for creating perforated corrugated board wherein the machine includes:
a) at least one apparatus configured to perforate (hereafter referred to as an “ACP”) corrugated board after the corrugated board exits a corrugator as part of a continuous process, so that the perforations are spread over at least a portion of the corrugated board.

According to the sixth aspect of the present invention there is provided closed cell coreboard which includes a plurality of substantially aligned perforations on each planar facing sheet positioned/spaced to create passages extending through the coreboard.

According to a seventh aspect of the present invention there is provided a machine for creating semi-perforated corrugated board wherein the machine includes:
at least one apparatus configured to perforate (hereafter referred to as an “ACP”) single face corrugated board after the corrugated board exits a corrugators as part of a continuous process; and
at least one double facing apparatus to laminate a non-perforated liner sheet to the perforated single face corrugated board.

In one embodiment the double facing apparatus may include a corrugated glue roller and one or more tensioned belt assemblies for holding the liner to the perforated single face paperboard.

According to an eighth aspect of the present invention there is provided a semi-perforated corrugated board which comprises:
a perforated single face layer; and
a non-perforated liner sheet layer.

It is envisaged the non-perforated liner sheet layer may be made of paper, or other suitable materials.

For ease of reference only, the “apparatus configured to perforate” the corrugated board, will be referred to as an ACP.

An important feature of the ACP is that it is configured to produce apertures of the size and spacing required to not compromise the strength of the corrugated board.

In preferred embodiments the ACP may be at least one laser assembly.

The laser assembly may include a plurality of lasers which are configured to create perforations in a sheet of material as it moves past the lasers.

The frequency at which the laser(s) may fire depends on the rate at which the sheet material is moving.

Preferably, the lasers may be operated in one or more groups to provide the ability to create different spatial patterns of perforations on a sheet material as may be required.

The laser assembly may be configured to operate in a variety of different ways without departing from the scope of the present invention.

In one preferred embodiment the laser assembly may include a programmable logic unit (PLU).

For example the PLU may be, programmed to cyclically fire the lasers at a given frequency for a given time to ensure the desired number, size and/or spacing, of perforations is achieved in the sheet material. Preferably the PLU is programmed to enable the lasers to form perforations in the sheet material as part of a continuous production process soon after the corrugated board is formed.

Preferably the PLU may be programmed to fire different groups of lasers at different times. The groups of lasers may form part of a single laser station. For instance, there may be a line of lasers which span across the width of sheet material, and different lasers within the line get activated at different times.

Alternatively, or in addition, the groups of lasers may be located in two or more separated laser stations.

For example, in some embodiments where a blank is to be formed from a sheet of material to create a carton, the base of the carton may require no perforations, or fewer perforations, than the walls of the carton. Alternatively, some embodiments may have perforations in the base and/or top of the carton which are located in a specific location, so as to maximise airflow or other fluid flow. The perforations in the base and top of the carton may also have different dimensions and/or shape than those in the walls.

The ACP may be in the form of a spiked apparatus.

According to a ninth aspect there is provided a box or bin which has been manufactured from semi-perforated corrugated board.

In some preferred embodiments the spiked apparatus may be a spiked conveyor belt assembly. The spiked conveyor belt assembly includes a conveyor belt which has a surface including one or more portions covered with a plurality of spikes. The assembly arranged so that spikes on the belt can contact and penetrate through the corrugated board. In general it is envisaged that the speed of the spiked conveyor belt and the corrugated board may be matched to one another.

The spiked conveyor belt may have a plurality of spikes projecting from the surface of the belt arranged randomly or spaced a set distance apart over the entire surface of the belt, or in a distinct spatial pattern on one or more surface portions of the belt.

The spiked conveyor belt assembly may be arranged in a variety of different ways.

In a preferred embodiment the spiked conveyor belt assembly may be arranged so the spikes can perforate the corrugated board by the longitudinal axis of the spike belt assembly being angled at substantially 45 degrees to the corrugated board. The inventor has found this arrangement helps ensure a clean perforation is made without ripping or tearing the corrugated board.

In another embodiment the spiked apparatus may be in the form of a press plate which has a series of spikes projecting from the surface of the plate. The plate tracks the corrugated board as it travels along a region of the conveyor system in a manner that allows the plate to stay aligned with the corrugated board during the tracking process to allow the plate to move downwardly so as to press the spikes through the corrugated board.

In some further preferred embodiments the spiked apparatus may have the spikes arranged in a spatial pattern which corresponds to the shape of the blank to be formed from a sheet material.

For example, in some embodiments where the blank is to be formed into a carton, the base of the carton may require no perforations, or fewer perforations, than the walls of the carton. Alternatively, some embodiments may have perforations in the base and/or top of the carton which are located in a specific location, so as to maximise airflow or other fluid flow. The perforations in the base and top of the carton may also have different dimensions and/or shape than those in the walls.

In some embodiments the ACP may perforate corrugated board as it exits the corrugating apparatus as part of a continuous process.

Thus, preferred embodiments of the present invention can have a number of advantages over the prior art which can include one or more of the following:
providing a simple, inexpensive and effective way of creating corrugated board which is breathable and/or allows fluids to travel from one side of the corrugated board to the other;
providing corrugated board which is breathable;
providing a breathable box which has increased structural integrity;
providing a way of producing a corrugated board box which is breathable but which does not involve cutting holes and/or removing material from the walls of the box nor any additional steps of adding mesh to cover the holes;
providing a semi-perforated corrugated board which has improved thermal conductivity over conventional non-perforated corrugated board; and providing a breathable corrugated paperboard without unduly comprising structural strength.

### BRIEF DESCRIPTION OF DRAWINGS

Further aspects of the present invention will become apparent from the following description which is given by way of example only and with reference to the accompanying drawings in which:

FIG. 1: shows a diagrammatic cross sectional view of portion of paperboard in accordance with one preferred embodiment of the present invention;

FIG. 2: shows a diagrammatic view of the top side of a sheet of material as shown in FIG. 1;

FIG. 3: shows a schematic view of a spiked conveyor belt assembly in accordance with one embodiment of the present invention;

FIG. 4: shows a diagrammatic partial close up of the spiked roller in accordance with another embodiment of the present invention showing a close up of the spiked roller performing a perforation operation on a sheet of single face paperboard;

FIG. 5: shows a diagrammatic partial close up of a sheet of closed cell coreboard in accordance with one preferred embodiment of the present invention;

FIG. 6: shows a diagrammatic plan view of a spiked conveyor having spikes arranged in a spatial pattern which corresponds to the shape of a blank to be formed from the sheet material;

FIG. 7: shows a diagrammatic end on view of a laser assembly used to create perforations as part of a continuous paperboard manufacturing process;

FIG. 8: shows a schematic side view of the laser assembly in FIG. 7; and

FIG. 9: shows a schematic front view of a preferred embodiment of spiked roller assembly;

FIG. 10: shows a schematic perspective view of the spiked roller assembly in FIG. 9;

FIG. 11: shows a side view of the spiked roller assembly in FIGS. 9, 10 and 11;

FIG. 12: shows a schematic view of a machine for use in the production of perforated paperboard intermediate bulk bins via a continuous process; and

FIG. 13: shows a schematic view of a machine for use in the production of semi-perforated double face paperboard.

### BEST MODES FOR CARRYING OUT THE INVENTION

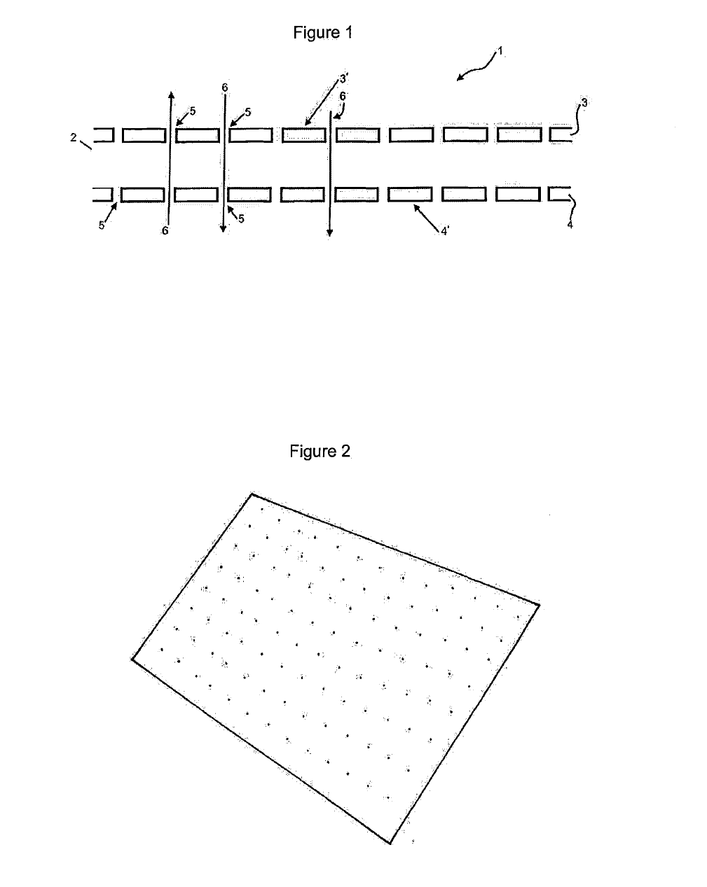

With respect to the FIGS. 1 and 2 there is provided a sheet of corrugated board (paperboard) 1 made from Kraft paper. The paperboard 1 has a sheet of corrugated paper 2 bonded to planar sheets of paper 3 and 4 on the top and bottom surfaces thereof. The paperboard 1 has a plurality of perforations 5 which run from the top surface 3′ through the corrugated core 2 to exit on the bottom surface 4′ of the paperboard 1. The perforations thereby provide a pathway as indicated by arrows 6 through which air or water can travel from one side of the paperboard to the other.

Preferably the paperboard is made via a cold process such as described in the applicant's PCT application (WO 2009/157786). The advantage of using a cold process is that the perforations can be formed in the paperboard as part of a continuous in-line production process for the creation of paperboard. By way of contrast if a hot corrugation process is used the paperboard needs time to dry and cool before perforations can be formed to avoid tearing of the soft paper exiting the hot corrugating rollers.

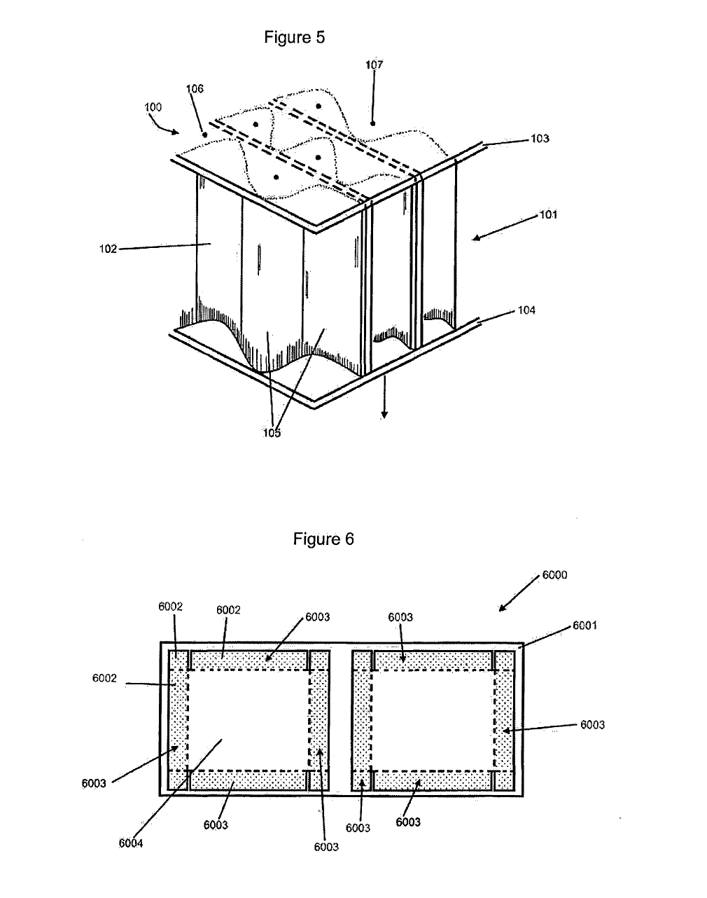

With respect to FIG. 5 there is shown a portion of closed cell coreboard 100. The closed cell coreboard 100 has a layer 101 made of strips 102 of single face corrugated board which is bonded to facing sheets 103 and 104. Each individual strip 102 is glued along the top and bottom edges thereof so that the corrugations (flutes) 105 of the strips 102 run vertically between facing sheets 103 and 104. The facing sheets 103,104 include a plurality of perforations 106 (only visible on the top facing sheet 103). The perforations 106 allow air as shown by arrow 107 to travel from one side of the board to the other.

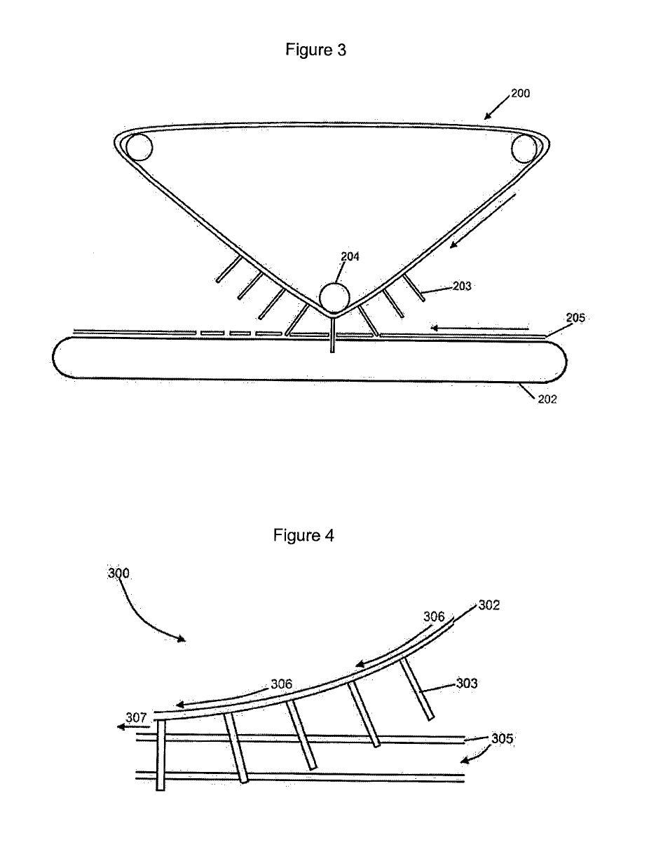

With respect to FIG. 3 there is provided a spiked conveyor apparatus 200 which is located above a standard horizontal conveyor belt assembly 201. The spiked conveyor apparatus 200 has a continuous belt 202 which has a series of spikes 203 projecting therefrom and covering the outer surface thereof (of which only a few are shown). The spiked conveyor apparatus 200 has a tension roller 204 which angles the outer surface of the conveyor belt 202 to approximately 45 degrees both towards and away from the plane of paperboard 205 which is to be perforated.

FIG. 3 also shows in greater detail the spikes 203 as the spikes 203 enter the paperboard 205 to create the perforations. The speed of the continuous belt 202 is matched to the speed of the paperboard 205 and is in the same general direction of the paperboard 205 see arrows 206 and 207. The paperboard 205 is moving on a multiple belt conveyor apparatus 209 with gaps between the belts allowing the spikes 203 to protrude through the paperboard 205. It will be appreciated that the paperboard 205 may be single face, double face as shown in FIG. 1 or closed cell coreboard as shown in FIG. 5.

FIG. 4 shows a spiked roller 300 which has an outer surface 302 which has a plurality of spikes 303 thereon. The spikes 303 enter the single face paperboard 305 to create perforations therein. The speed of the spiked roller 302 is matched to the speed of the paperboard 305 and is in the same general direction of the paperboard 305 see arrows 306 and 307.

In FIG. 6 there is shown a spiked conveyor 6000 which has a continuous conveyor belt 6001 which has plurality of spikes 6002 which are arranged to correspond to a blank to be formed in the sheet of material. The spikes 6002 are located on the conveyor belt in a region 6003 which will correspond with wall sections on the blank (not shown) but spikes are not located on the conveyor in a region 6004 which will correspond with the base on the blank. As can be seen the conveyor belt has a repeating spike pattern which enables multiple blanks to be perforated during travel of the conveyor belt.

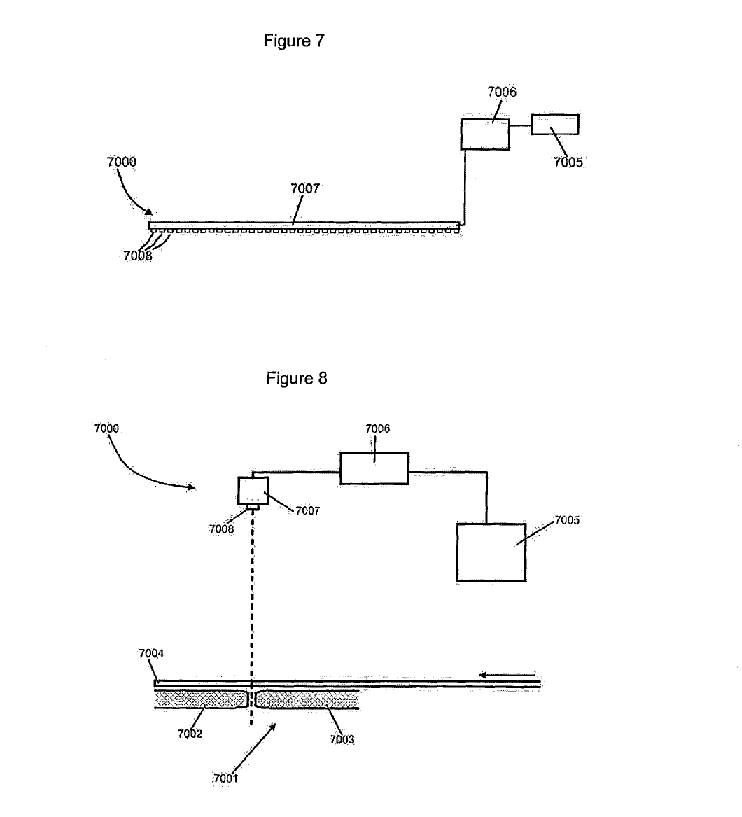

In FIGS. 7, 8 and 9 there is shown a laser assembly 7000 which is located above a conveyor system 7001 which consists of two conveyors 7002 and 7003 which convey recently formed continuous paper sheet material 7004 there along as part of a continuous production process for manufacturing paperboard.

The laser assembly includes a control panel 7005 connected to a PLU 7006 which is operateably connected to a single laser station 7007. The laser station 7007 has a multitude of lasers 7008 therein which can via the PLU be fired together as a single group, or fired as one or more sub-groups, as well as individually fired, as may be required. In use, a person simply utilises the control panel to select how it wants the PLU to control the firing of the lasers within the laser station 7007.

The following example illustrates one of many ways in which the laser station of FIG. 8 may be employed in practice.

### Example 1

In this example the paper sheet material is in the form of a double face paperboard which is being conveyed at the rate of 2 m/s. The lasers 7008 are all being fired simultaneously at a rate of 500 times per second to give a spacing between longitudinally and transversely aligned perforations of 4 mm apart wherein said perforations are substantially 0.5 mm² in size.

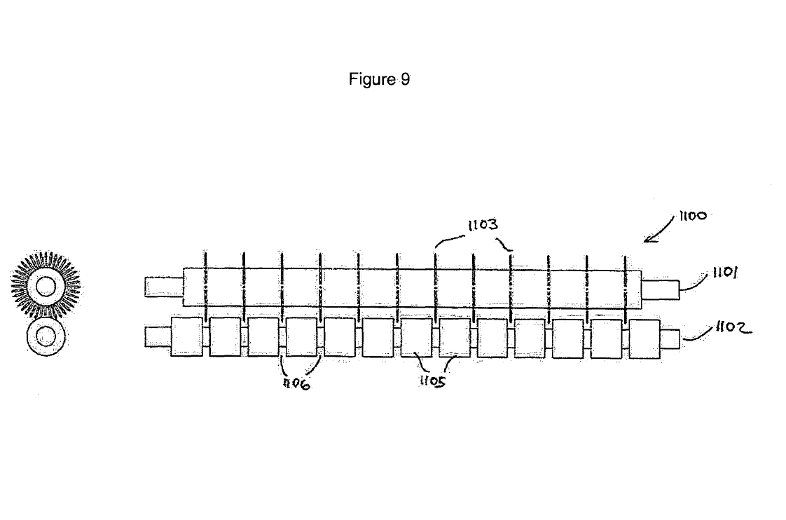

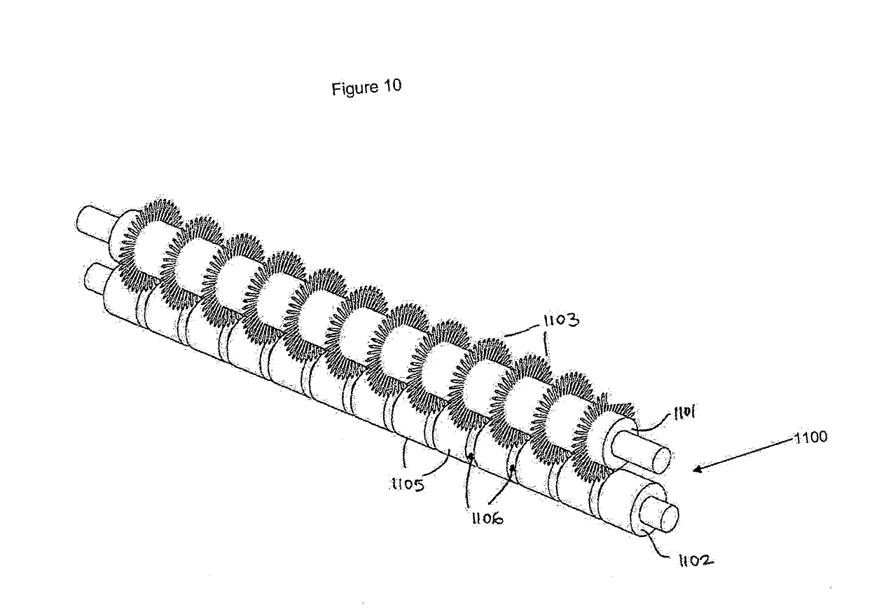

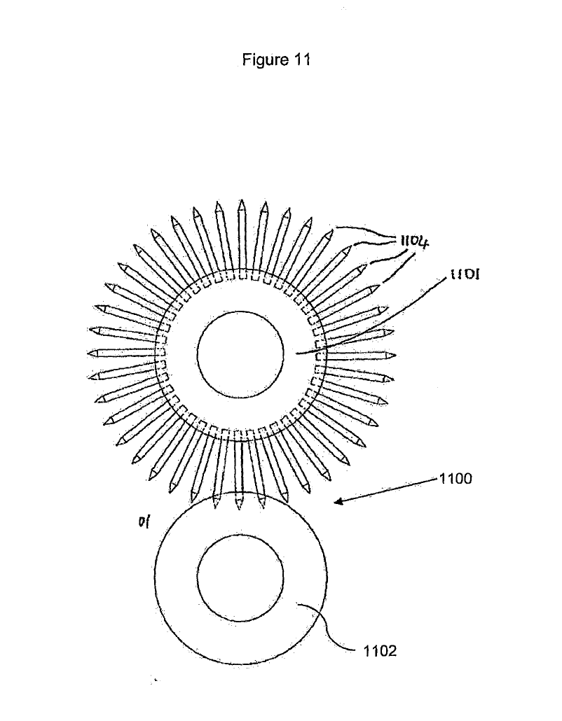

FIGS. 9-11 shows an ACP in the form of a spiked roller apparatus generally indicated by arrow 1100. The ACP 1100 has a spiked roller 1101 and a support roller 1102. The spiked roller has a plurality of bands 1103 of radially projecting spikes 1104. The support roller has a series of collars 1105 separated by a gap 1106 which receives the spikes which have penetrated a sheet of paper material not shown which passes between spiked roller 1101 and support roller 1102.

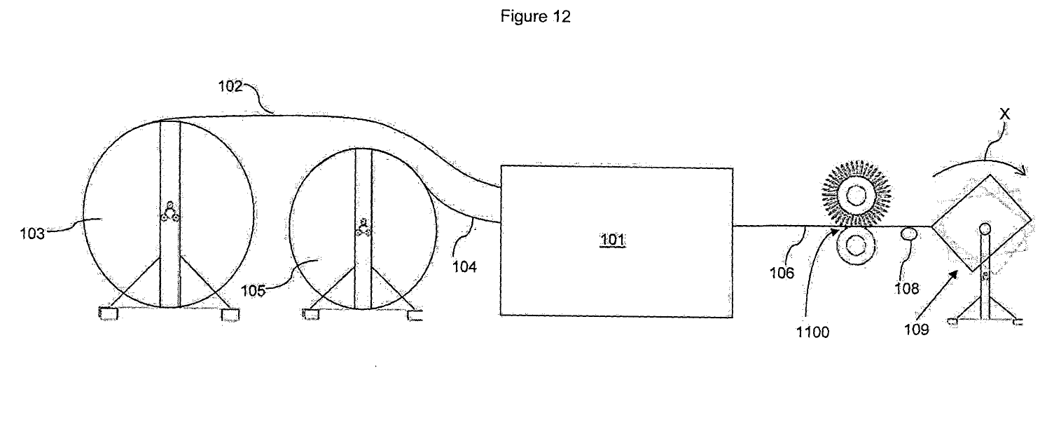

With respect to FIG. 12 there is a shown a machine 100 for manufacturing single face paperboard for use in collapsible paperboard intermediate bulk containers as part of a single continuous process.

The machine 100 has Corcel™ Cold Process corrugator 101 which is fed planar liner sheet material 102 from a first reel of virgin Kraft paper 103 and recycled paper 104 from a second reel 105 which is to be corrugated within the corrugator 101.

The recycled paper once corrugated has glue applied via glue roller (not shown) and is then bonded to the liner sheet material 102 to form single face paperboard 106. The single face paperboard 106 exits the corrugator 101 and is fed through a spike roller apparatus 1100 which perforates the single face paperboard 106 just prior to glue being applied to the corrugated surface of the paperboard via glue roller 108 before it is fed to a winder apparatus 109 which rotates in the direction indicated by arrow X. The winder apparatus 109 is well known in the art and creates multi-laminated side walls (usually between 4-10 layers of single face paperboard) for a collapsible intermediate bulk bin container.

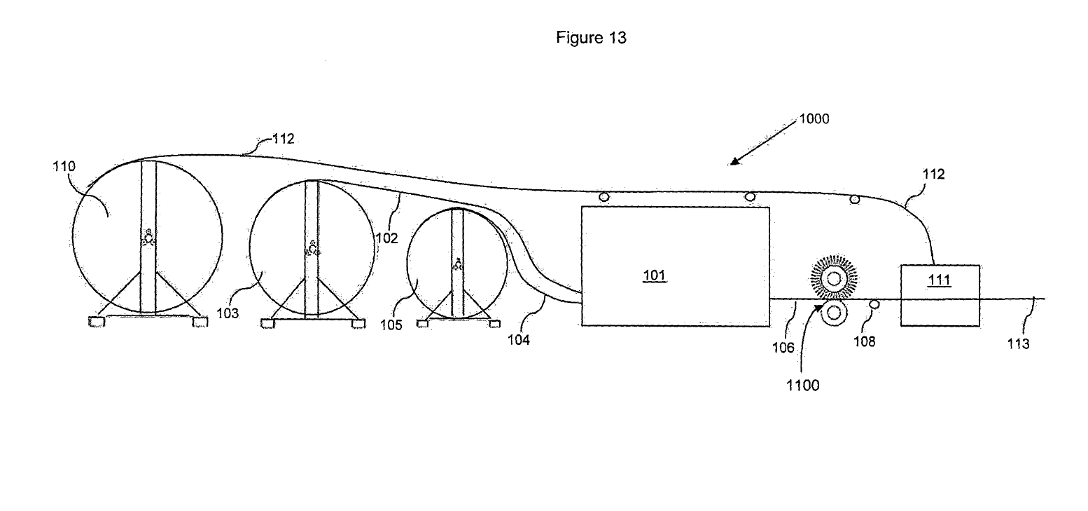

FIG. 13 shows a machine 1000 for manufacturing semi-perforated double face paperboard which is very similar that already detailed in relation to FIG. 12 with the notable exception it employs a double facing station 111 in place of the winder apparatus 109. For this reason like reference numerals to FIG. 12 have been used to refer to like elements and the discussion focuses on the differences of the machine 1000 in FIG. 13.

The machine 1000 has an additional reel of virgin Kraft paper 110, which holds planar liner sheet material 112. The planar liner sheet material 112 is not perforated and is to be laminated to the perforated single face paperboard 106, at a double facer laminating station in the form of a double facing apparatus 111.

The result of laminating a non-perforated liner sheet 112 to the perforated single face paperboard 109 is semi-perforated double paperboard 113.

Aspects of the present invention have been described by way of example only and it should be appreciated that modifications and additions may be made thereto without departing from the scope the appended claims.

What we claim is:

1. A corrugated board which includes:
a sheet of corrugated material; and
at least one planar sheet of material bonded to at least one surface of said sheet of corrugated material;
wherein said corrugated sheet and planar sheet(s) include a plurality of perforations spread over at least a portion of the respective surfaces thereof which are substantially aligned to create passages through the corrugated board, wherein the perforations are dimensioned to be substantially 0.5 mm²-2.00 mm² in size and spaced at least substantially 4 mm-10 mm apart from one another.

2. A method of manufacturing perforated corrugated board characterised by the step of:
a) forming perforations through the corrugated board once the corrugated board has been formed by bonding liner sheet(s) to a corrugated core as part of a continuous process wherein said perforations are spread over at least a portion of the corrugated board.

3. A machine for creating perforated corrugated board wherein the machine includes:
a) at least one apparatus configured to perforate (hereafter referred to as an “ACP”) corrugated board after a corrugated board exits the corrugator as part of a continuous process, so that the perforations are spread over at least a portion of the corrugated board.

4. A machine as claimed in claim 3 wherein the ACP is at least one laser assembly.

5. A machine as claimed in claim 4 wherein the lasers may be operated in one or more groups to provide the ability to create different spatial patterns of perforations on a sheet material as required.

6. A machine as claimed in claim 3 wherein the ACP is in the form of a spiked apparatus.

7. A machine as claimed in claim 6 wherein the spiked apparatus is a spiked conveyor belt assembly.

8. A machine as claimed in claim 7 wherein the spiked conveyor belt assembly includes a conveyor belt which has a surface including one or more portions covered with a plurality of spikes.

9. A machine as claimed in claim 8 wherein the spiked conveyor belt has a plurality of spikes projecting from the surface of the belt arranged randomly or spaced a set distance apart over the entire surface of the belt, or in a distinct spatial pattern on one or more surface portions of the belt.

10. A machine as claimed in claim 6 wherein the conveyor belt has the spikes arranged in a spatial pattern which corresponds to the shape of the blank to be formed from a sheet material.

11. A closed cell coreboard which includes a plurality of substantially aligned perforations on each planar facing sheet positioned/spaced to create passages extending through the coreboard

12. A box or bin which has been manufactured from closed cell coreboard as claimed in claim 11.

13. A machine for creating semi-perforated corrugated board wherein the machine includes:
at least one apparatus configured to perforate (hereafter referred to as an “ACP”) single face corrugated board after a corrugated board exits the corrugator as part of a continuous process;
at least one double facing apparatus to laminate a non-perforated liner sheet to the perforated single face corrugated board.

14. A semi-perforated corrugated board which comprises:
a perforated single face layer; and
a non-perforated liner sheet layer.

15. A box or bin which has been manufactured from semi-perforated corrugated board.
